(19) United States
(12) Patent Application Publication
(10) Pub. No.: US 2024/0273337 A1
(43) Pub. Date: Aug. 15, 2024

(54) METHOD FOR PROVIDING DEVELOPMENT ENVIRONMENT BASED ON REMOTE EXECUTION

(71) Applicant: MakinaRocks Co., Ltd., Seoul (KR)

(72) Inventors: Daesung KIM, Guri-si (KR); Hwiyeon CHO, Seoul (KR); Hongji KIM, Seoul (KR)

(73) Assignee: MakinaRocks Co., Ltd., Seoul (KR)

(21) Appl. No.: 18/434,192

(22) Filed: Feb. 6, 2024

(30) Foreign Application Priority Data
Feb. 15, 2023 (KR) 10-2023-0019772

(51) Int. Cl. G06N 3/04; G06F 9/455; G06N 3/084

(52) U.S. Cl. CPC G06N 3/04; G06F 9/45558; G06N 3/084; G06F 2009/4557; G06F 2009/45595

(57) ABSTRACT

Disclosed is a method for providing a development environment. Specifically, according to the present disclosure, a computing device identifies a plurality of components included in an entire pipeline, recommends an execution environment in which each component is to be executed based on information on each of the plurality of components; and executes the plurality of components based on the recommendation, and the execution environment includes a remote execution environment.

### CROSS-REFERENCE TO RELATED APPLICATIONS

This application claims priority to and the benefit of Korean Patent Application No. 10-2023-0019772 filed in the Korean Intellectual Property Office on Feb. 15, 2023, the entire contents of which are incorporated herein by reference.

### TECHNICAL FIELD

The present disclosure relates to a method for providing a development environment based on remote execution, and particularly, to a method for determining an execution environment in which each component is to be executed based on information on a plurality of components included in an entire pipe line, and executing at least some of the plurality of components.

### BACKGROUND ART

In the field of computer programming, including the development of artificial intelligence models, the amount of computation required for each component included in the entire pipeline of a program is different. If the program includes components that require a large computational workload, such as developing the artificial intelligence model, the entirety or a part of the program can be executed on a computer with a high computation capability, which is connected to cloud computing or offline.

However, in cases where it is difficult to know how large computational workload each component requires or when a large number of users are using a cloud computing environment, there is a possibility that choosing a location in which the program is to be executed due to human intuition will lead to rather increasing a time for which the entire program is executed.

Therefore, there is a demand in the industry for a method that can efficiently execute the program considering various types of execution environments.

Korea Patent Registration No. 10-2442577 discloses a method for providing a development environment.

### SUMMARY OF THE INVENTION

The present disclosure is contrived in response to the above-described background art, and has been made in an effort to determine an execution environment in which each component is to be executed based on information on a plurality of components included in an entire pipe line, and execute at least some of the plurality of components.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method for providing a development environment, which is performed by a computing device. The method may include: identifying a plurality of components included in an entire pipeline; recommending an execution environment in which each component is to be executed based on information on each of the plurality of components; and executing the plurality of components based on the recommendation, and the execution environment may include a remote execution environment.

In an exemplary embodiment, the execution environment may be independently separated and operated depending on a user.

In an exemplary embodiment, the type of execution environment may include at least one of one or more local terminals, one or more computer clusters, or one or more cloud services.

In an exemplary embodiment, the recommending of the execution environment in which each component is to be executed based on the information on each of the plurality of components may include generating information of one or more execution environments; and recommending the execution environment for each component included in the plurality of components to be executed based on information of the one or more execution environments and the information on the plurality of respective components.

In an exemplary embodiment, the recommending the execution environment for each component included in the plurality of components to be executed based on the information of the one or more execution environments and the information on the plurality of components may include generating information related to a computational workload required for executing the respective components, and recommending the execution environment for each component included in the plurality of components to be executed based on the information of the one or more execution environments and the information related to the computational workload.

In an exemplary embodiment, the generating of the information related to the computational workload required to execute each component may include identifying elements included in each component, extracting parameter information from each of the elements, and generating information related to a computational workload required to execute each component based on the elements and the parameter information.

In an exemplary embodiment, the recommending the execution environment for each component included in the plurality of components to be executed based on the information of the one or more execution environments and the information related to the computational workload may include generating prediction time information required for each component to be executed in the one or more execution environments by using an artificial neural network model, and recommending the execution environment for each component included in the plurality of components to be executed based on the prediction time information.

In an exemplary embodiment, the method may further include identifying execution time information required to execute each component; and updating the artificial neural network model based on the execution time information.

In an exemplary embodiment, the recommending of the execution environment in which each component is to be executed based on the information of the one or more execution environments and the information on each of the plurality of components may include identifying whether each component includes a specific framework or library, and recommending the execution environment for each component included in the plurality of components to be executed based on the identified result.

In an exemplary embodiment, the executing of the plurality of components based on the recommendation may include determining an execution environment in which each of the plurality of components is to be executed based on the recommendation, and executing the plurality of components on the determined execution environment based on the determination.

In an exemplary embodiment, the executing of the plurality of components in the execution environment based on the determination may include transmitting information of a package required for executing each component to an execution environment in which the corresponding component is to be executed, and receiving an execution result for each component from the execution environment.

In an exemplary embodiment, the executing of the plurality of components based on the recommendation further include reusing execution results for at least some of the plurality of components when cache data is utilized in an execution process, and executing the plurality of components when the cache data is not utilized in the execution process.

Another exemplary embodiment of the present disclosure provides a computer program which allows a computing device to perform operations for providing a development environment. The operations may include: an operation of identifying a plurality of components included in an entire pipeline; an operation of recommending an execution environment in which each component is to be executed based on information on each of the plurality of components; and an operation of executing the plurality of components based on the recommendation, and the execution environment may include a remote execution environment.

Still another exemplary embodiment of the present disclosure provides a computing device for providing a development environment. The computing device may include: a processor including one or more cores; and a memory, and the process may include identifying a plurality of components included in an entire pipeline, recommending an execution environment in which each component is to be executed based on the information on each of the plurality of components, and executing the plurality of components based on the recommendation, and the execution environment may include a remote execution environment.

According to the present disclosure, there is an effect of efficiently executing a program. For example, according to the present disclosure, an appropriate execution environment can be determined, in which each component is to be executed based on information on a plurality of components included in an entire pipeline, and at least some of the plurality of components can be executed.

### BRIEF DESCRIPTION OF THE DRAWINGS

FIG. 1 is a block diagram of a computing device for providing a development environment according to an exemplary embodiment of the present disclosure.

FIG. 2 is a schematic view illustrating a network function according to an exemplary embodiment of the present disclosure.

FIG. 3 is a flowchart illustrating a process of providing a development environment according to an exemplary embodiment of the present disclosure.

FIG. 4 is a conceptual view illustrating components and an execution environment according to an exemplary embodiment of the present disclosure.

FIG. 5 is a conceptual view illustrating a process in which an artificial neural network model generates predicted time information required for each component to be executed in one or more execution environments according to an exemplary embodiment of the present disclosure.

FIG. 6 is a conceptual view illustrating a process in which the component is executed in the execution environment according to an exemplary embodiment of the present disclosure.

FIG. 7 is a simple and normal schematic view of an exemplary computing environment in which the exemplary embodiments of the present disclosure may be implemented.

### DETAILED DESCRIPTION

The present disclosure discloses a method for determining an execution environment in which each component is to be executed based on information on a plurality of components included in an entire pipeline of a computer program, and executing at least some of the plurality of components.

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or”. That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, ‘execution environment’ may mean a computer in which a component is executed or a service for using a resource of the computer. For example, when information on a component is transmitted to a computer linked with a cloud computing service through a network unit 150 and executed on the computer, a computer linked with a cloud computing service and the cloud computing service may correspond to the execution environment. Each execution environment may be present in a place or a remote place such as a development environment provided by the present disclosure. Additionally, one execution environment may be independently separated and operated depending on a user. For example, if a computing resource of the execution environment called X are commonly shared by user k and user j, 60% of the computing resources of X may be assigned to user k and the remaining 40% of the computing resources of X may be assigned to user j.

In the present disclosure, the type of execution environment may include a local terminal, a computer cluster, and a cloud computing service, but is not limited thereto.

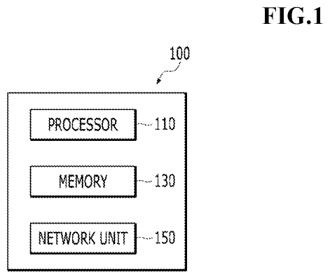

FIG. 1 is a block diagram of a computing device for providing a development environment according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like.

At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

The processor 110 may identify software to be executed, i.e., a plurality of components included in an entire pipeline of a computer program. At this time, all components that constitute the pipeline may be identified, and only some of the components connected to the pipeline may be identified. Each component may have a relationship associated by pipelines executed in sequence. In the present disclosure, results output from a plurality of components, respectively may form an input of one component, and a result output from one component may form inputs of the plurality of components.

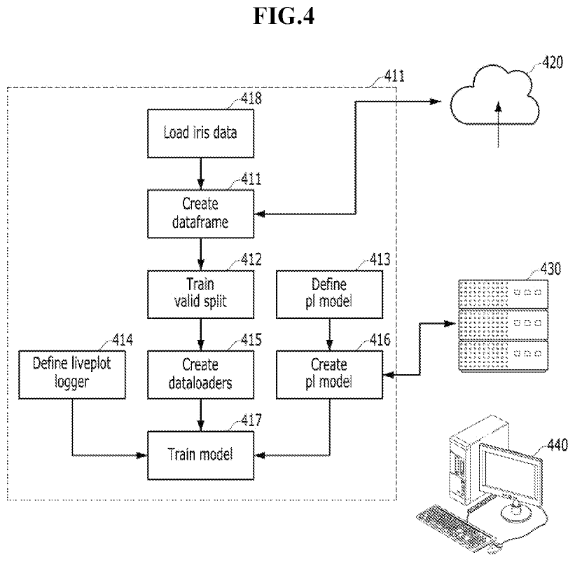

The processor 110 may recommend an environment in which each component is to be executed, based on information about each of the identified plurality of components. For example, the processor 110 may identify that one program is constituted by three components A, B, and C, and then, based on information on A, B, and C, recommend A to be executed in the local terminal, B to be executed in the computer cluster, and C to be executed in the cloud service. A specific method for recommending the execution environment will be described later with reference to FIG. 4.

As a first method for recommending the environment in which the component is to be executed, the processor 110 may generate information related to a computational workload required to execute each component, and recommend an execution environment in which each component is to be executed using the information related to the computational workload.

In this case, the processor 110 may identify the components included in respective components to generate the information related to the computational workloads required to execute the respective components, extract parameter information for each component, and then based on the component and the parameter information, generate the information related to the computational workloads required to execute the respective components.

For example, when the component to be executed includes a machine learning model, the processor 110 may use information on the number of parameters of the machine learning model to generate the information related to the computational workload. A method for calculating the number of parameters of the machine learning model is widely known to those skilled in the art of artificial intelligence, and may be sufficiently implemented simply by the description of this specification.

Specifically, a situation may be assumed in which when the components A, B, and C included in the pipeline all include the machine learning models, the numbers of parameters of machine learning models included in respective components A, B, and C identified by the processor 110 are 5000, 7000, and 10000, respectively. At this time, the processor 110 may set information related to the computational workload of component A to 5000, information related to the computational workload of component B to 7000, and information related to the computational workload of component C to 10000, and generate information related to a computational workload in the form of a real number of 0 or more.

The processor 110 may then generate information on a prediction time required for each component to be executed in one or more currently available execution environments based on the information related to the computational workload required to execute each component.

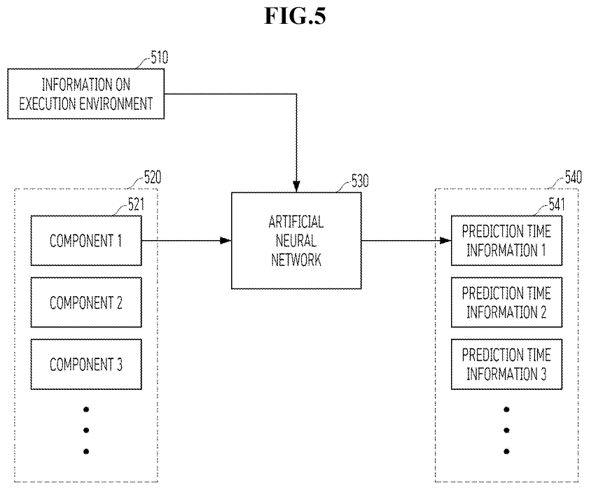

In an exemplary embodiment of the present disclosure, the information on the prediction time required for each component to be executed may be performed by a separate artificial neural network model. A specific method of generating the prediction time information by the artificial neural network model will be described later with reference to FIG. 5.

As a second method for recommending an environment in which the component is to be executed, the processor 110 may identify whether each component includes a specific framework or library. Thereafter, the processor 110 may recommend an execution environment in which each component is to be executed based on the identified result. For example, when the component contains a library that requires a high-specification resource or contains a specific code such as the machine learning model, the processor 110 may recommend to the corresponding component to be executed in an execution environment with the highest computation capability among the currently available execution environments.

The processor 110 may execute the components included in the entire pipeline based on recommendations.

In the present disclosure, the processor 110 may execute each component in an execution environment recommended for each component, or may execute each component by receiving an input for selecting the execution environment of the user. For example, when it is recommended to execute component A in execution environment X, component B in execution environment Y, and component C in execution environment Z, the processor 110 may execute component A in execution environment X, component B in execution environment Y, and component C in execution environment Z by reflecting the above recommendation as it is. Additionally, the processor 110 may receive an input of the user to change the execution environments recommended in A and B, and execute component A in execution environment Y, component B in execution environment X, and component C in execution environment Z.

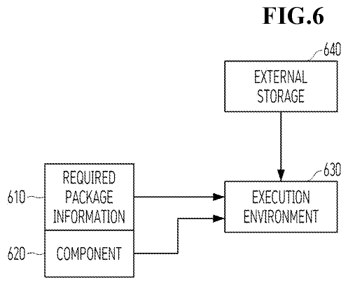

In the present disclosure, when a plurality of components are executed in respective execution environments, the processor 110 may transmit information of a package required to execute each component to the execution environment in which the corresponding component is to be executed. A specific method for transmitting the information on the package will be described later with reference to FIG. 6.

In the present disclosure, some of the plurality of components may have been executed in the past, and the execution results may be stored in the form of cache data. When executing the plurality of components, the processor 110 may utilize cache data of some components, that is, reuse the execution results. Through this, rather than executing all of a plurality of components each time, the execution time of all components may be shortened by reusing values that have already been executed and stored.

By the present disclosure, by recommending an execution environment optimized for the processor 110 to execute each component in the entire program, the processor 110 may distribute the components to the respective execution environments through a consistent standard without relying on human intuition. Therefore, due to the development environment provided by the present disclosure, the time required to execute the entire program is shortened, and the efficiency of performing tasks such as machine learning models is dramatically increased.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit (150) can utilize various forms of wired and wireless communication systems.

The technologies described in this specification can be used not only in the mentioned networks but also in other networks.

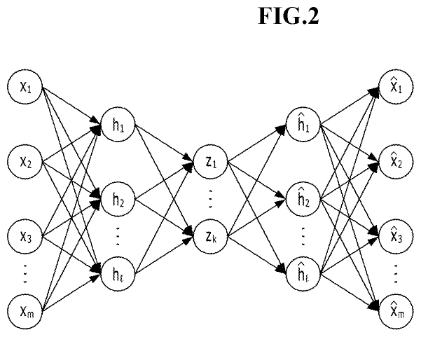

FIG. 2 is a schematic diagram illustrating a network function according to the embodiment of the present disclosure.

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the embodiment of the present disclosure, the number of nodes of the input layer may be the same as the number of nodes of the output layer, and the neural network may be in the form that the number of nodes decreases and then increases again from the input layer to the hidden layer. Further, in the neural network according to another embodiment of the present disclosure, the number of nodes of the input layer may be smaller than the number of nodes of the output layer, and the neural network may be in the form that the number of nodes decreases from the input layer to the hidden layer. Further, in the neural network according to another embodiment of the present disclosure, the number of nodes of the input layer may be larger than the number of nodes of the output layer, and the neural network may be in the form that the number of nodes increases from the input layer to the hidden layer. The neural network according to another embodiment of the present disclosure may be the neural network in the form in which the foregoing neural networks are combined. A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

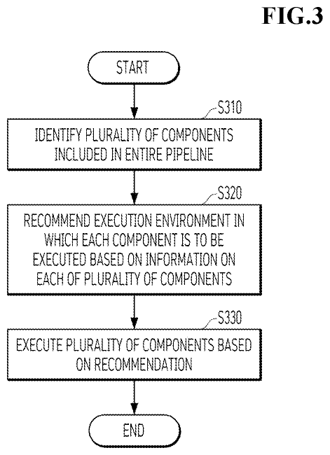

FIG. 3 is a flowchart illustrating a process of providing a development environment according to an exemplary embodiment of the present disclosure.

The process of providing the development environment according to the present disclosure may include a step S310 of identifying a plurality of components that constitutes an entire pipeline, a step S320 of recommending an execution environment in which each component is to be executed based on information on each of the plurality of components, and a step S330 of executing the plurality of components based on recommendation.

In step S310, the processor 110 may identify the plurality of components included in the entire pipeline. For example, when components A, B, C, D, E, and F are connected to each other through the pipeline, the processor 110 may receive an input from a user who selects the component and identify some components A, B, C, and D among the components.

In step S320, the processor 110 may recommend the execution environment in which each component is to be executed. A specific method for recommending the execution environment is described above with reference to FIG. 1. For example, when the identified components are A, B, C, and D and the available execution environments are X, Y, and Z, the processor 110 may recommend executing A and B in X, C in Y, and D in Z.

In step S330, the processor 110 may execute the plurality of components based on the recommendation. The processor 110 may execute each component by reflecting the execution environment recommended corresponding to each component as it is, but may receive an input of changing the execution environment of the user and reflecting the received input, and execute each component in each execution environment.

FIG. 4 is a conceptual view illustrating components and an execution environment according to an exemplary embodiment of the present disclosure.

In FIG. 4, the entire pipe line 410 may include a total of 8 components, ‘Load iris data’ 418, ‘Create dataframe’ 411, ‘Train valid split’ 412, ‘Define pl model’ 413, ‘Define liveplot logger’ 414, ‘Create dataloaders’ 415, ‘Create pl model’ 416, and ‘Train model’ 417.

The processor 110 may generate information on the execution environment for each of a cloud computing service 420, a computer cluster 430, and a local terminal 440 which are currently available execution environments. At this time, the information on the execution environment may include the number of nodes in each execution environment, the number of CPUs constituting the node, the number of cores included in the CPU, a capacity of a memory, the number of GPUs, and the number of cores included in the GPU. However, in the present disclosure, the information on the execution environment is not limited to the above example, and various elements that determine computing resources may be included in the information on the execution environment.

The processor 110 may generate information related to the computational workload required to execute each component, and recommend the execution environment in which each component is to be executed based on the information on the execution environment and the information related to the computational workload. The method for generating the information related to the computational workload is described above with reference to FIG. 1. For example, the processor 110 may express the information related to the computational workload required to execute each component illustrated in FIG. 4 as a real number of 0 or more, and determine a computational workload of the component ‘Load iris data’ 418 as 10, the component ‘Create dataframe’ 411 as 5000, the component ‘Train valid split’ 412 as 20, the component ‘Define pl model’ 413 as 5, the component ‘Define liveplot logger’ 414 as 20, the component ‘Create dataloaders’ 415 as 10, the component ‘Create pl model’ 416 as 1000, and the component ‘Train model’ 417 as 10.

Thereafter, the processor 110 may recommend to execute the component ‘Create dataframe’ 411 having a highest computational workload required for execution in the cloud computing service 420, execute the component ‘Create pl model’ 416 having a next highest computational workload in the computer cluster 430, and execute the remaining components in the local terminal 440.

FIG. 5 is a conceptual view illustrating a process in which an artificial neural network model generates predicted time information required for each component to be executed in one or more execution environments according to an exemplary embodiment of the present disclosure.

The artificial neural network model 530 of the present disclosure may receive information 510 on an available execution environment and information 520 related to a computational workload for an identified component, and output prediction time information 540 required to execute the corresponding component in each execution environment. For example, the processor 110 may receive information on execution environment X (Single node: [CPU(4 core), Memory 32 GB]), information on execution environment Y (Single node: [CPU(8 Core), two GPUs, Memory 6 GB]), information on execution environment Z (Multi-node: Node1: [CPU (8 Core), four GPUs, Memory 32 GB], Node2: [CPU(32 Core), four GPUs, Memory 2 GB]), and information 5000 on a computational workload of component 1 521 by using the artificial neural network model, and generate prediction time information 1 541 required for component 1 521 to be executed in execution environments X, Y, and Z. The processor 110 may repeat the same task for all components identified using the artificial neural network model.

The processor 110 may recommend the execution environment in which each component is to be executed based on the prediction time information 540 required for each component to be executed in each execution environment. For example, processor 110 may recommend a component-execution environment combination computed to have the smallest sum of prediction times required to execute all components.

The artificial neural network model of the present disclosure may be continuously updated according to a use of a development environment. For example, the artificial neural network model may identify execution time information required to execute each component, and the artificial neural network model may be updated based on the execution time information. Specifically, the artificial neural network model may compare the prediction time required to execute the component in the execution environment, and an actually required time, and additionally learned in order to reduce a difference between the times.

FIG. 6 is a conceptual view illustrating a process in which the component is executed in the execution environment according to an exemplary embodiment of the present disclosure.

In the present disclosure, when a component is executed in an execution environment, a situation may occur in which a package required to execute the component is not installed in the execution environment, or only a different version of package is installed.

In the present disclosure, the processor 110 may transmit package information 610 required to execute a component 620 to an execution environment 630, and the computing device that manages the execution environment may check whether the required package is installed in the execution environment 630, and then when the required package is not installed or a version is different, may install or reinstall a package required in an external storage 640.

Thereafter, the processor 110 may allow the component 620 to be executed in the execution environment 630 and then receive an execution result for the component 620 from the execution environment.

In addition, in the present disclosure, the execution environment may be independently separated and operated depending on the user, so in an execution environment sharing computing resources (hardware), it is possible for multiple users to individually install a part in which the packages required to execute the component is assigned to the user. When further described with reference to FIG. 6, the processor 110 may transmit user information (not illustrated) to the execution environment 630 in addition to the required package information 610. Thereafter, when the required package is not installed in the part assigned to the user, the package may be installed in the execution environment 630 using the external storage 640 or the like.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

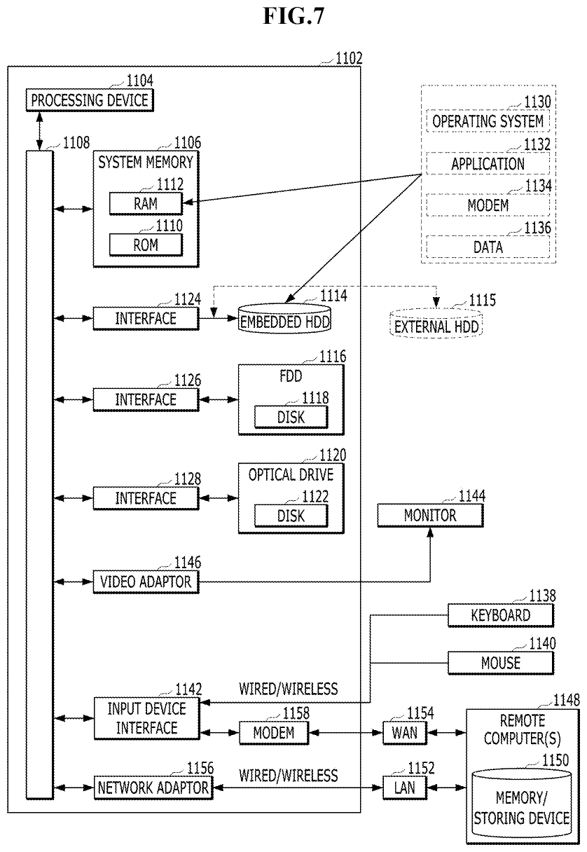

FIG. 7 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))-the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method for providing a development environment performed by a computing device, the method comprising:
identifying a plurality of components included in an entire pipeline;
recommending an execution environment for each component included in the plurality of components to be executed based on information on each of the plurality of components; and
executing the plurality of components based on the recommendation,
wherein the execution environment includes a remote execution environment, and
wherein the recommending of the execution environment for each component included in the plurality of components to be executed based on the information on each of the plurality of components includes:
generating information related to a computational workload required to execute each component, and
recommending the execution environment for each component included in the plurality of components to be executed based on information of one or more execution environments and the information related to the computational workload.

2. The method of claim 1, wherein the execution environment is enabled to be independently separated and operated depending on a user.

3. The method of claim 1, wherein a type of execution environment includes at least one of:
one or more local terminals,
one or more computer clusters, or
one or more cloud computing services.

4. The method of claim 1, wherein the generating of the information related to the computational workload required to execute each component includes:
identifying elements included in each component,
extracting parameter information from each of the elements, and
generating the information related to the computational workload required to execute each component based on the elements and the parameter information.

5. The method of claim 1, wherein the recommending the execution environment for each component included in the plurality of components to be executed based on the information of the one or more execution environments and the information related to the computational workload includes:
generating prediction time information required for each component to be executed in the one or more execution environments by using an artificial neural network model, and
recommending the execution environment for each component included in the plurality of components to be executed based on the prediction time information.

6. The method of claim 5, further includes:
identifying execution time information required to execute each component; and
updating the artificial neural network model based on the execution time information.

7. The method of claim 1, wherein the recommending of the execution environment for each component included in the plurality of components to be executed based on the information of the one or more execution environments and the information related to the computational workload includes:
identifying whether each component includes a specific framework or library, and
recommending the execution environment for each component included in the plurality of components to be executed based on the identified result.

8. A method for providing a development environment performed by a computing device, the method comprising:
identifying a plurality of components included in an entire pipeline;
recommending an execution environment for each component included in the plurality of components to be executed based on information on each of the plurality of components; and
executing the plurality of components based on the recommendation,
wherein the execution environment includes a remote execution environment,
wherein the executing of the plurality of components based on the recommendation includes:
determining an execution environment for each component included in the plurality of components to be executed based on the recommendation, and
executing the plurality of components on the determined execution environment based on the determination, and
wherein the executing of the plurality of components on the determined execution environment based on the determination includes:
transmitting information of a package required for executing each component to an execution environment in which each component is to be executed, and
receiving an execution result for each component from the execution environment.

9. The method of claim 1, wherein the executing of the plurality of components based on the recommendation further includes:
reusing execution results for at least some of the plurality of components when cache data is utilized in an execution process, and
executing the plurality of components when the cache data is not utilized in the execution process.

10. A computer program stored in a non-transitory computer readable storage medium, the computer program causing a computing device to perform operations for providing a development environment by a computing device, the operations comprising:
an operation of identifying a plurality of components included in an entire pipeline;
an operation of recommending an execution environment for each component included in the plurality of components to be executed based on information on each of the plurality of components; and
an operation of executing the plurality of components based on the recommendation,
wherein the execution environment includes a remote execution environment, and
wherein the operation of recommending of the execution environment for each component included in the plurality of components to be executed based on the information on each of the plurality of components includes:
an operation of generating information related to a computational workload required to execute each component, and
an operation of recommending the execution environment for each component included in the plurality of components to be executed based on information of one or more execution environments and the information related to the computational workload.

11. The computer program of claim 10, wherein the operation of recommending of the execution environment for each component included in the plurality of components to be executed based on the information of the one or more execution environments and the information related to the computational workload includes:
an operation of generating prediction time information required for each component to be executed in the one or more execution environments by using an artificial neural network model, and
an operation of recommending the execution environment for each component included in the plurality of components to be executed based on the prediction time information.

12. The computer program of claim 11, wherein the operations further include:
an operation of identifying execution time information required to execute each components; and
an operation of updating the artificial neural network model based on the execution time information.

13. A computing device comprising:
a processor including one or more cores; and
a memory,
wherein the processor is configured to:
identify a plurality of components included in an entire pipeline,
recommend an execution environment for each component included in the plurality of components to be executed based on information on each of the plurality of components, and
execute the plurality of components based on the recommendation,
wherein the execution environment includes a remote execution environment, and
wherein the recommending of the execution environment for each component included in the plurality of components to be executed based on the information on each of the plurality of components includes:
generating information related to a computational workload required to execute each component, and
recommending the execution environment for each component included in the plurality of components to be executed based on information of one or more execution environments and the information related to the computational workload.

14. The computing device of claim 13, wherein the recommending of the execution for each component included in the plurality of components to be executed based on the information of the one or more execution environments and the information related to the computational workload includes:
generating prediction time information required for each component to be executed in the one or more execution environments by using an artificial neural network model, and
recommending the execution environment for each component included in the plurality of components to be executed based on the prediction time information.

15. The computing device of claim 14, wherein the processor further configured to:
identify execution time information required to execute each component; and
update the artificial neural network model based on the execution time information.
